(19) United States
(12) Patent Application Publication
(10) Pub. No.: US 2023/0087202 A1
(43) Pub. Date: Mar. 23, 2023

(54) Augmented Reality And Touch-Based User Engagement Parking Assist

(71) Applicant: Ford Global Technologies, LLC, Dearborn, MI (US)

(72) Inventors: Erick Lavoie, Van Buren Charter Township, MI (US); Ryan Gorski, Grosse Pointe Farms, MI (US); Bo Bao, Bloomfield, MI (US); Siyuan Ma, Detroit, MI (US)

(73) Assignee: Ford Global Technologies, LLC, Dearborn, MI (US)

(21) Appl. No.: 17/478,541

(22) Filed: Sep. 17, 2021

(51) Int. Cl. G05D 1/00; G06F 3/0488; H04W 4/02; H04W 4/40

(52) U.S. Cl. CPC G05D 1/0016; G05D 1/005; G05D 1/0022; G06F 3/0488; H04W 4/026; H04W 4/40; G05D 2201/0213

(57) ABSTRACT

The present disclosure is directed to systems and methods for rapid switching between an Augmented Reality engagement interface and an orbital motion engagement interface operating via mobile device application. The application may be used to remotely control remote vehicle parking assist functions of a semi-autonomous vehicle. The HMI quick switch system may present two or more user interfaces as alternative options that may allow the user to command a vehicle to perform remote parking assist functions using a securely connected (tethered) mobile device connecting to the vehicle and providing indication of active user engagement with the remote parking assist operations. The HMI quick switch system evaluates user engagement using a complex gesture and video input using the mobile device sensors. By providing an intuitive fast switching interface, a user may provide greater attention to the vehicle and task at hand without undue focus on complex interface actions.

### FIELD

The present disclosure relates to vehicle maneuvering systems, and more particularly, to an augmented reality (AR) and touch-based user engagement switch for remote vehicle parking assistance.

### BACKGROUND

Vehicle parking assist systems may provide an interface that allows a user to operate a vehicle remotely by providing an automated steering controller that provides the correct steering motion to move the vehicle to a parking position. Without an automated control mechanism, it can be counter-intuitive to manually steer a vehicle to provide the correct inputs at the steering wheel to direct the vehicle to a desired parking position.

Remote control of the driving vehicle from a location outside of the vehicle can also be challenging, even for Level-2 and Level-3 vehicle autonomy. Some conventional systems for remote control of a parking-assisted vehicle may require an orbital motion on the phone screen to enable vehicle motion. Additionally, the user may be required to carry a key fob for the tethering function. In other known and conventional systems, the user may begin the user engagement and vehicle/mobile device tethering functions by aiming the mobile device camera at the vehicle they wish to operate remotely.

The camera technology may be limited to usage where the camera can see the vehicle. For example, if too much of the vehicle is covered by snow or in low light conditions, the mobile device may not be able to lock onto the vehicle, and the user may be required to demonstrate user engagement using tactile feedback to the mobile device interface such as tracing an orbital or user-defined pattern.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 depicts a functional schematic of an example control system that may be configured for use in a vehicle in accordance with the present disclosure.

FIG. 3 illustrates mobile device directionality in accordance with embodiments of the present disclosure.

FIG. 4 depicts the mobile device of FIG. 1 generating an aspect of Remote Driver Assist Technology (ReDAT) parking functionality in accordance with embodiments of the present disclosure.

FIG. 5 depicts an AR engagement interface displayed by the mobile device 120, in accordance with embodiments of the present disclosure.

FIG. 6 illustrates the mobile device of FIG. 1 switching from an orbital motion engagement interface to an AR engagement user interface in accordance with embodiments of the present disclosure.

FIG. 7 depicts the mobile device of FIG. 1 providing an augmented reality (AR) user interface that receives camera-based user engagement inputs in accordance with embodiments of the present disclosure.

FIG. 8 depicts a flow diagram of an example method for switching a Human Machine Interface (HMI) in accordance with the present disclosure.

### DETAILED DESCRIPTION

### Overview

The systems and methods disclosed herein may be configured and/or programmed to provide rapid switching between an AR engagement interface and an orbital motion engagement interface operating on a mobile device application. Two or more user interfaces may be alternative options that may allow the user to command a vehicle to perform remote functions (for example, remote parking) using a securely connected (tethered) mobile device that connects to the vehicle and provides aspects of user engagement indications.

In some aspects, the AR engagement interface may direct the user to aim their phone camera at the vehicle to perform the remote function. The mobile device orientation and viewing angle observed by the mobile device camera sensors can provide affirmative indications that the user is actively engaged in the parking procedure.

According to another aspect, the HMI quick switch system may provide an orbital motion engagement interface where the HMI quick switch system instructs the user to provide an orbital input on the mobile device screen to indicate user engagement sufficient to activate the remote parking assist functionality of the vehicle. AR user engagement may improve positive user experience when the scene provides adequate light and circumstances such as clear line of sight and proper mobile device orientation toward the vehicle. However, AR user engagement may not be useable in all scenarios (for example, if there is too much snow on the vehicle, not enough light in the environment, etc.). In such cases, the orbital motion user engagement via a tethered mobile device may be required to be used instead.

A first approach to the HMI quick switch system may include one or more of the following example embodiments. In a first embodiment, the HMI quick switch system may receive a user selection via the mobile device processor, where the input selects the desired remote function on the mobile device, causing the processor to connect to an enabled vehicle via a wireless data connection. The HMI quick switch system may generate user-selectable options that cause the mobile device to issue instructions to the vehicle that cause the vehicle to engage the RePA functionality and perform a parking maneuver.

In one aspect, the vehicle based AR quick switch HMI system may determine that the remote parking functionality onboard the vehicle is ready to begin vehicle motion, and transmit a confirmation signal to the mobile device using the wireless data connection. Responsive to determining that the mobile device includes a tethering technology that supports orbital motion user engagement determination via the mobile device screen, such as UWB, the HMI quick switch system may generate instructions that guide the user to properly aim and engage their attention for remote operation. For example, the HMI quick switch system may cause the mobile device to output a user coaching interface, and generate instructions that can cause user to either aim the mobile device camera at the vehicle, or provide an orbital input on the screen to begin vehicle motion for the desired vehicle feature. The orbital input may provide a positive indication that the user is actively engaged in the remote parking procedure.

In other aspects, the coaching output may further include text and/or voice such as “Aim Camera at Vehicle OR Trace an Orbital Motion on the Screen.” The HMI quick switch system may display a color shape (e.g., a green orbital shape, for example) on the screen of the mobile device in the same color as the text “Trace an Orbital Motion on the Screen” while there may be rotating outline of a vehicle displayed inside brackets on the screen in the same color as the text “Aim Camera at Vehicle,” but a different color from the orbital shape. Responsive to aiming the mobile device camera at the vehicle, the application may cause the mobile device processor lock onto the vehicle via UWB tethering, and cause the orbital shape and text to disappear from the user interface. The processor may cause the mobile device to output a message requesting that the user press and hold a vehicle motion button.

According to another aspect of the present disclosure, the HMI quick switch system may provide one or more of optical and orbital motion engagement options via separate portions of the screen.

The application may be functional using portrait and landscape viewing modes for the mobile device. For example, in landscape mode, the user can start the tethering function by either using the camera to aim the vehicle on the left side of the screen or start to trace the orbital shape on the right side. In other aspects, when the mobile device is used in portrait mode, the processor may cause the device to output a graphic of the vehicle and brackets on the top of the screen, while the orbital shape is generated to appear on the bottom of the screen. A Human-Machine Interface (HMI) associated with the selected option may illuminate, which may indicate a type of engagement the user is currently providing during tethering.

In one example embodiment, the user may aim their mobile device camera at the vehicle, and the application may lock onto the vehicle. During the tethering process, the HMI quick switch system may provide a switchable user interface such that the user can switch engagement options by following the instruction on the screen. Responsive to determining that the user wants to shift from optical engagement to orbital motion engagement, the HMI quick switch system may provide instructions that causes the user to (1) move the camera away from the vehicle and/or (2) start tracing the orbital shape on the right side of the screen after the HMI lights up. Responsive to determining that the user wants to shift from orbital motion engagement to optical engagement, the HMI quick switch system may generate instructions causing the user to (1) point the camera back to the vehicle, (2) stop the orbital motion, and/or (3) start holding the highlighted button again.

In another aspect, the HMI quick switch system may include a third option for quickly switching between control modes. Starting with the same concept of the user beginning a remote vehicle function, before presenting any additional screens to the user, the processor may cause the application to evaluate mobile device sensor data, and determine one or more control options to be made available to the user. The mobile device sensors may determine an orientation and attitude of the mobile device, which may be used to select and output an optimized interface. For example, the processor may display an orbital motion engagement interface responsive to determining that the mobile device is in portrait mode. Accordingly, the HMI quick switch system may display an AR engagement interface when the mobile device is in landscape mode.

Based on operational expectations of the mobile device’s orientation and attitude, if either change during operational use, or do not fall within the guidelines of expected states, the processor may determine if the user has lost focus/awareness and is presenting a “lack of intent” scenario. For example, using orientation and attitude to measure user intent and determine if the user has lost concentration/focus/awareness, the HMI quick switch system may remind the user (e.g., by displaying a sound, visual, haptic, or other output) indicative that the user is performing a safety-related activity. Responsive to determining that the mobile device is in a state requiring the mobile device’s orientation and/or attitude to be within certain positions, and/or after determining that the mobile device’s position does not qualify for any particular set capabilities, the HMI quick switch system may generate one or more pulsing, vibrating and/or audio clues to re-focus user attention given to the vehicle control activity.

The HMI quick switch system may pulse audio, haptic, or graphical reminders. For example, the HMI quick switch system may pulse a set of graphics by continuously changing the opacity/transparency of user interface graphics from variations that can include mostly transparent to mostly opaque graphical representations of the scene. In one aspect, the HMI quick switch system may generate the output using one or more predetermined limits for opacity and transparency, and/or one or more predetermined pulsing rates that vary according to the circumstances.

According to another aspect, responsive to determining that a set of graphics for one user interface (UI) is actively engaged, system may transition to a different UI functionality such that UI’s set of graphics maintain a 100% opacity while the other (currently unused UI set of graphics) are pulsed based on the predetermined limits and at rate.

Responsive to determining that neither user interface is actively engaged, the processor may cause all available sets of graphics to pulse in opposition to each other, such that they pulse back and forth between each respective set of graphics. In the case of two sets of user interface graphics being available for use, the HMI quick switch system may cause both sets of graphics to pulse inversely to each other, by causing one set of UI graphics to become increasingly transparent, as the other set of UI graphics becomes increasingly opaque.

In another aspect, when the HMI quick switch system includes three or more sets of user interfaces that are available for use given the particular scene and orientation of the mobile device, the HMI quick switch system may cause one or more of the three sets of graphics to sequentially pulse between transparent and opaque, such that only one set of the three sets becomes more opaque, while the other two sets of the three available sets is displayed by transitioning from opaque to transparent or mostly transparent. In one or more embodiments, the HMI quick switch system may generate the output as mostly transparent, then become increasingly opaque with respective pulses.

According to another aspect of the present disclosure, the HMI quick switch system may cause one or more graphics of the three sets of graphics to change based on battery level for the mobile device. For example, the HMI quick switch system may determine that less than a threshold battery power level remains, and may cause one or more graphics of the three sets of graphics to change a level of transparency and/or become unelectable.

Embodiments described in this disclosure may evaluate user engagement using a complex gesture, and video input using the mobile device sensors to indicate affirmative user engagement with vehicle steering or other similar functions. By providing an intuitive interface, a user may provide greater attention to the vehicle and task at hand without undue focus on complex interface operation.

These and other advantages of the present disclosure are provided in greater detail herein.

### Illustrative Embodiments

The disclosure will be described more fully hereinafter with reference to the accompanying drawings, in which example embodiments of the disclosure are shown, and not intended to be limiting.

Many mobile devices may include Ultra-Wide Band (UWB) communication functionality. The present disclosure is directed to systems and methods for rapid switching between an Augmented Reality engagement interface and an orbital motion engagement interface operating via mobile device application. The application may be used to remotely control remote vehicle parking assist functions of a semi-autonomous vehicle. The HMI quick switch system may present two or more user interfaces as alternative options that may allow the user to command a vehicle to perform remote parking assist functions using a securely connected (tethered) mobile device connecting to the vehicle and providing indication of active user engagement with the remote parking assist operations. The HMI quick switch system evaluates user engagement using a complex gesture and video input using the UWB and mobile device sensors. By providing an intuitive fast switching interface, a user may provide greater attention to the vehicle and task at hand without undue focus on complex interface actions.

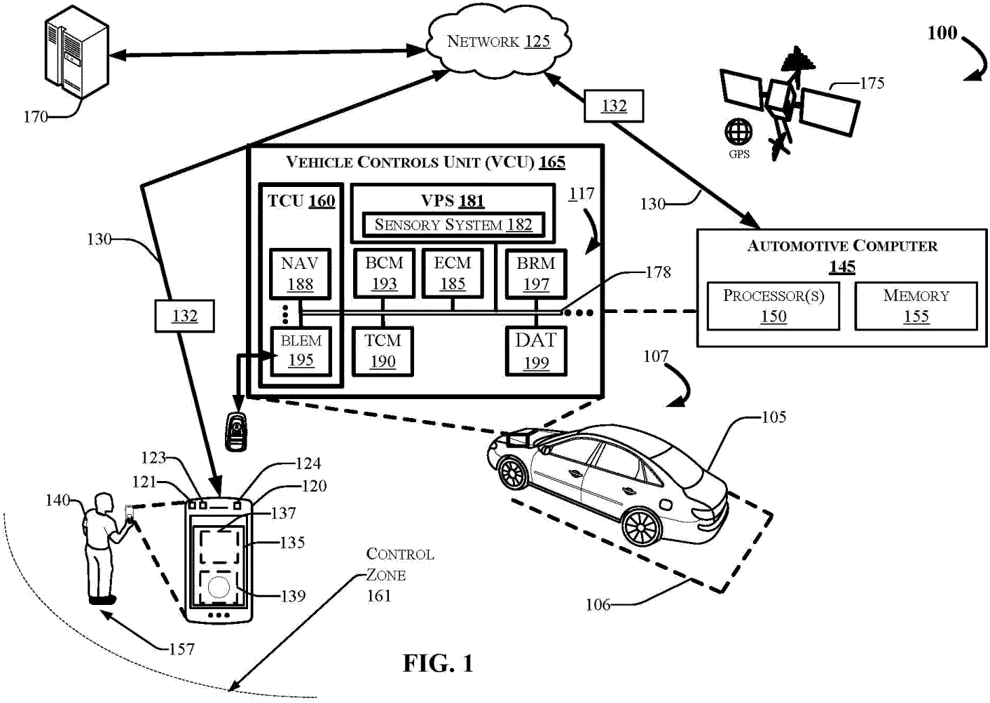

FIG. 1 depicts an example computing environment 100 that can include a vehicle 105. The vehicle 105 may include an automotive computer 145, and a Vehicle Controls Unit (VCU) 165 that can include a plurality of electronic control units (ECUs) 117 disposed in communication with the automotive computer 145. A mobile device 120, which may be associated with a user 140 and the vehicle 105, may connect with the automotive computer 145 using wired and/or wireless communication technologies and transceivers. The mobile device 120 may be communicatively coupled with the vehicle 105 via one or more network(s) 125, which may communicate via one or more wireless connection(s) 130, and/or may connect with the vehicle 105 directly using near field communication (NFC) , Bluetooth^{®}, Wi-Fi, Ultra-Wide Band (UWB), and other possible data connection and sharing techniques.

The vehicle 105 may also receive and/or be in communication with a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with the mobile device 120, and one or more server(s) 170. The server(s) 170 may be part of a cloud-based computing infrastructure, and may be associated with and/or include a Telematics Service Delivery Network (SDN) that provides digital data services to the vehicle 105 and other vehicles (not shown in FIG. 1) that may be part of a vehicle fleet.

Although illustrated as a sedan, the vehicle 105 may take the form of another passenger or commercial automobile such as, for example, a truck, a sport utility, a crossover vehicle, a van, a minivan, a taxi, a bus, etc., and may be configured and/or programmed to include various types of automotive drive systems. Example drive systems can include various types of internal combustion engines (ICEs) powertrains having a gasoline, diesel, or natural gas-powered combustion engine with conventional drive components such as, a transmission, a drive shaft, a differential, etc. In another configuration, the vehicle 105 may be configured as an electric vehicle (EV). More particularly, the vehicle 105 may include a battery EV (BEV) drive system, or be configured as a hybrid EV (HEV) having an independent onboard powerplant, a plug-in HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features.

A vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location 157 remote from the vehicle 105 but within a control zone 161 extending up to several meters from the vehicle 105 while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the HMI quick switch system is unable to execute the task.

Level-4 AVs can operate independently from a human driver, but may still include human controls for override operation. Level-4 automation may also enable a self-driving mode to intervene responsive to a predefined conditional trigger, such as a road hazard or a system failure.

Level-5 AVs may include fully autonomous vehicle systems that require no human input for operation, and may not include human operational driving controls.

According to embodiments of the present disclosure, the HMI quick switch system 107 may be configured and/or programmed to operate with a vehicle having a Level-1 through Level-4 autonomous vehicle controller. Accordingly, the HMI quick switch system 107 may provide some aspects of human control to the vehicle 105, when the vehicle is configured as an AV.

The mobile device 120 can include a memory 123 for storing program instructions associated with an application 135 that, when executed by a mobile device processor 121, performs aspects of the disclosed embodiments. The application (or “app”) 135 may be part of the HMI quick switch system 107, or may provide information to the HMI quick switch system 107 and/or receive information from the HMI quick switch system 107.

In some aspects, the mobile device 120 may communicate with the vehicle 105 through the one or more wireless connection(s) 130, which may be encrypted and established between the mobile device 120 and a Telematics Control Unit (TCU) 160. The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless connection(s) 130 are depicted in FIG. 1 as communicating via the one or more network(s) 125, and via one or more wireless connection(s) 133 that can be direct connection(s) between the vehicle 105 and the mobile device 120. The wireless connection(s) 133 may include various low-energy technologies including, for example, Bluetooth^{®}, Bluetooth^{®} Low-Energy (BLE^{®}), UWB, Near Field Communication (NFC), and/or Car Connectivity Consortium Digital Key BLE, among other methods.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication technologies such as, for example, transmission control protocol/Internet protocol (TCP/IP), User Datagram Protocol/Internet protocol (UDP/IP) Bluetooth^{®}, BLE^{®}, Logical Link Control Adaptation Protocol (L2CAP), Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the HMI quick switch system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases not shown in FIG. 1). The processor(s) 150 may utilize the memory 155 to store programs in code and/or to store data for performing aspects in accordance with the disclosure. The memory 155 may be a non-transitory computer-readable memory storing an HMI quick switch program code. The memory 155 can include any one or a combination of volatile memory elements (e.g., dynamic random access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The VCU 165 may share a power bus 178 with the automotive computer 145, and may be configured and/or programmed to coordinate the data between vehicle 105 systems, connected servers (e.g., the server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Driver Assistances Technologies (DAT) controller 199, etc. The VCU 165 may further include and/or communicate with a Vehicle Perception System (VPS) 181, having connectivity with and/or control of one or more vehicle sensory system(s) 182. In some aspects, the VCU 165 may control operational aspects of the vehicle 105, and implement one or more instruction sets received from the application 135 operating on the mobile device 120, from one or more instruction sets stored in computer memory 155 of the automotive computer 145, including instructions operational as part of the HMI quick switch system 107.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a BLE^{®} Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth^{®} and BLE^{®} communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests, and connect directly with the mobile device 120, and/or one or more keys (which may include, for example, the fob 179).

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high-speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the HMI quick switch system 107, and/or the server(s) 170, etc.), and may also communicate with one another without the necessity of a host computer. The bus 180 may connect the ECUs 117 with the automotive computer 145 such that the automotive computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication technologies, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers, inputs from an autonomous vehicle controller, the HMI quick switch system 107, and/or via wireless signal inputs received via the wireless connection(s) 133 from other connected devices such as the mobile device 120, among others. The ECUs 117, when configured as nodes in the bus 180, may each include a central processing unit (CPU), a CAN controller, and/or a transceiver (not shown in FIG. 1). For example, although the mobile device 120 is depicted in FIG. 1 as connecting to the vehicle 105 via the BLEM 195, it is possible and contemplated that the wireless connection 133 may also or alternatively be established between the mobile device 120 and one or more of the ECUs 117 via the respective transceiver(s) associated with the module(s).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems, AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

The DAT controller 199 may provide Level-1 through Level-3 automated driving and driver assistance functionality that can include, for example, active parking assistance (e.g., Remote Parking Assistance or RePA), trailer backup assistance, adaptive cruise control, lane keeping, and/or driver status monitoring, among other features. The DAT controller 199 may also provide aspects of user and environmental inputs usable for user authentication. Authentication features may include, for example, biometric authentication and recognition.

The DAT controller 199 can obtain input information via the sensory systems 182, which may include sensors disposed on the vehicle interior and/or exterior (sensors not shown in FIG. 1). The DAT controller 199 may receive the sensor information associated with driver functions, vehicle functions, and environmental inputs, and other information. The DAT controller 199 may characterize the sensor information for identification of biometric markers stored in a secure biometric data vault (not shown in FIG. 1) onboard the vehicle 105 and/or via the server(s) 170.

According to aspects of the present disclosure, the DAT controller 199 may further receive inputs via a tethered mobile device, such as the mobile device 120. Accordingly, the DAT may receive input data indicative of user engagement with RePA operations.

In other aspects, the DAT controller 199 may also be configured and/or programmed to control Level-1 and/or Level-2 driver assistance when the vehicle 105 includes Level-1 or Level-2 autonomous vehicle driving features. The DAT controller 199 may connect with and/or include a Vehicle Perception System (VPS) 181, which may include internal and external sensory systems (collectively referred to as sensory systems 181). The sensory systems 182 may be configured and/or programmed to obtain sensor data usable for biometric authentication, and for performing driver assistances operations such as, for example, active parking, trailer backup assistances, adaptive cruise control and lane keeping, driver status monitoring, and/or other features.

The vehicle PaaK system (not shown in FIG. 1) determines and monitors a location for a PaaK-enabled mobile device relative to the vehicle location in order to time broadcasting a pre-authentication message to the mobile device 120, or another passive key device such as the fob 179. As the mobile device 120 approaches a predetermined communication range relative to the vehicle position, the mobile device may transmit a preliminary response message to the PaaK-enabled vehicle. The vehicle PaaK system may cache the preliminary response message until a user associated with the authenticating device performs an unlock action such as actuating a vehicle door latch/unlatch mechanism by pulling a door handle, for example. The PaaK system may unlock the door using data already sent to the pre-processor to perform a first level authentication without the delay associated with full authentication steps.

The computing system architecture of the automotive computer 145, VCU 165, and/or the HMI quick switch system 107 may omit certain computing modules. It should be readily understood that the computing environment depicted in FIG. 1 is an example of a possible implementation according to the present disclosure, and thus, it should not be considered limiting or exclusive.

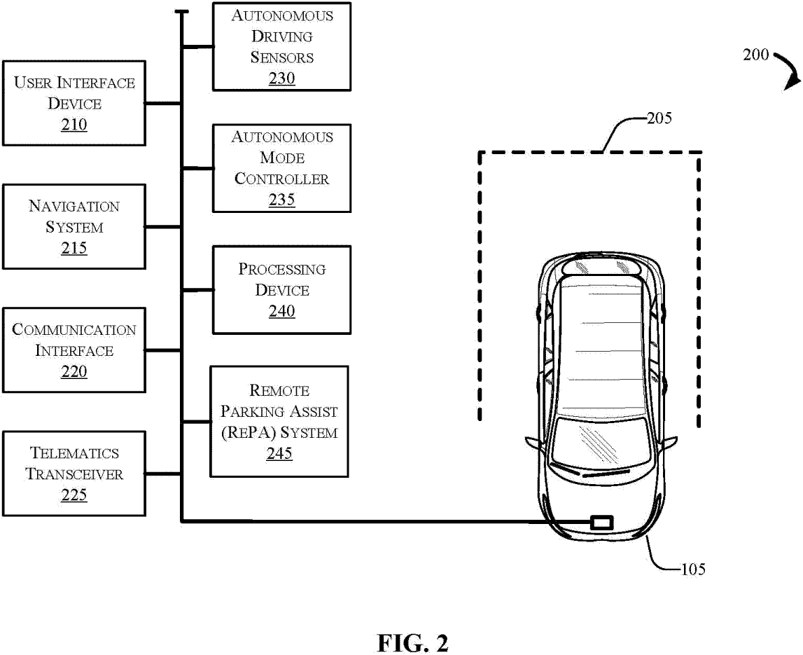

FIG. 2 illustrates an example functional schematic of a control system 200 that may be configured for use in an autonomous vehicle 105. The control system 200 can include a user interface 210, a navigation system 215, a communication interface 220, a telematics transceiver 225, autonomous driving sensors 230, an autonomous mode controller 235, and one or more processing device(s) 240.

The user interface 210 may be configured or programmed to present information to a user, such as, for example, the user 140 depicted with respect to FIG. 1, during operation of the vehicle 105. Moreover, the user interface 210 may be configured or programmed to receive user inputs, and thus, it may be disposed in or on the vehicle 105 such that it is viewable and may be interacted with by a passenger or operator. For example, in one embodiment where the vehicle 105 is a passenger vehicle, the user interface 210 may be localized in the passenger compartment of the vehicle 105. In one possible approach, the user interface 210 may include a touch-sensitive display screen (not shown in FIG. 2).

The navigation system 215 may be configured and/or programmed to determine a position of the vehicle 105, and/or determine a target position 106 to which the vehicle 105 is to be maneuvered. The navigation system 215 may include a Global Positioning System (GPS) receiver configured or programmed to triangulate the position of the vehicle 105 relative to satellites or terrestrial based transmitter towers. The navigation system 215, therefore, may be configured or programmed for wireless communication.

The communication interface 220 may be configured or programmed to facilitate wired and/or wireless communication between the components of the vehicle 105 and other devices, such as the mobile device 120 (depicted in FIG. 1), and/or a remote server (e.g., the server(s) 170 as shown in FIG. 1), or another vehicle (not shown in FIG. 2) when using a vehicle-to-vehicle communication protocol. The communication interface 220 may also be configured and/or programmed to communicate directly from the vehicle 105 to the mobile device 120 using any number of communication protocols such as Bluetooth®, Bluetooth® Low Energy, UWB, or Wi-Fi, among many others.

A telematics transceiver 225 may include wireless transmission and communication hardware that may be disposed in communication with one or more transceivers associated with telecommunications towers and other wireless telecommunications infrastructure (not shown in FIG. 2). For example, the telematics transceiver 225 may be configured and/or programmed to receive messages from, and transmit messages to one or more cellular towers associated with a telecommunication provider, and/or a Telematics Service Delivery Network (SDN) associated with the vehicle 105 (such as, for example, the server(s) 170 depicted with respect to FIG. 1). In some examples, the SDN may establish communication with a mobile device (e.g., the mobile device 120 depicted with respect to FIG. 1) operable by a user (e.g., the user 140), which may be and/or include a cell phone, a tablet computer, a laptop computer, a key fob, or any other electronic device. An internet connected device such as a PC, Laptop, Notebook, or Wi-Fi connected mobile device, or another computing device may establish cellular communications with the telematics transceiver 225 through the SDN.

The autonomous driving sensors 230 may include any number of devices configured or programmed to generate signals that help navigate the vehicle 105 while the vehicle 105 is operating in the autonomous (e.g., driverless) mode. Examples of autonomous driving sensors 230 may include a radar sensor, a lidar sensor, a vision sensor, or the like. The autonomous driving sensors 230 may help the vehicle 105 “see” the roadway and the vehicle surroundings and/or negotiate various obstacles while the vehicle is operating in the autonomous mode.

The autonomous mode controller 235 may be configured or programmed to control one or more vehicle subsystems while the vehicle is operating in the autonomous mode. Examples of subsystems that may be controlled by the autonomous mode controller 235 may include one or more systems for controlling braking, ignition, steering, acceleration, transmission control, and/or other control mechanisms. The autonomous mode controller 235 may control the subsystems based, at least in part, on signals generated by the autonomous driving sensors 230. In other aspects, the autonomous mode controller 235 may be configured and/or programmed to determine a position of the vehicle 105, determine a position of the vehicle 105, and/or determine a target position 106 to which the vehicle 105 is to be maneuvered, and control the vehicle 105 based on one or more inputs received from the mobile device 120. For example, the autonomous mode controller 235 may be configured to receive a configuration message comprising instructions for causing the autonomous vehicle controller 235 to position the vehicle 105 at the target position 106 based on user inputs. The autonomous mode controller 235 may engage the vehicle 105 based on the configuration message, such that the engaging maneuvers the vehicle 105 to a target position 106 by actuating the vehicle motor(s) (not shown in FIG. 2), steering components (not shown in FIG. 2) and other vehicle systems.

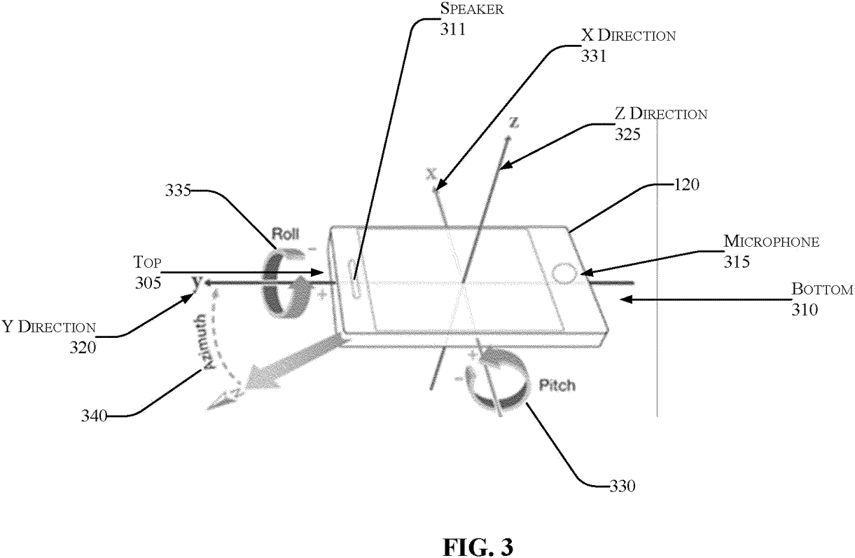

FIG. 3 illustrates mobile device directionality in accordance with embodiments of the present disclosure. As explained above, the HMI quick switch system 107 may provide provides novel User Interfaces (UIs) that enables the user 140 to quickly switch between an AR HMI a complex gesture HMI to indicate affirmative user engagement with parking operations. The user 140 may indicate their user engagement with the touch sensitive systems (e.g., 135, 139) on the mobile device 120 (shown in FIG. 1).

As described herein, the mobile device 120 may be used in various positions with respect to the horizontal plane (e.g., the surface of the Earth). For example, when referring to the mobile device 120 as if the device were being held to the user’s ear to make a phone call, a top portion 305 of the mobile device 120 may be defined as a location of a primary speaker 311. A bottom portion 310 of the mobile device 120 may be defined as a location of a primary microphone 315.

The illustration of FIG. 3 shows the mobile device 120 centered on an (X, Y) planes of a standard (X, Y, Z) Cartesian Coordinate system. Embodiments of the present disclosure describe uses of the mobile device 120 where the mobile device 120 is held in the user’s hand or hands (user 140 not shown in FIG. 3), where the mobile device 120 is primarily centered along the (Y, Z) planes (320, 325 respectively).

In some aspects, the processor 121 (shown in FIG. 1) may determine if the mobile device 120 is oriented such that the mobile device adequately captures the scene including the vehicle 105 as it performs the RePA procedure. The processor 121 may determine this based on several factors, such as pitch 330, roll 335, and azimuth 340, and attitude. These various aspects may change based on orientation and use of the mobile device 120 in portrait mode or landscape mode.

Portrait mode describes a mobile device orientation where the mobile device 120 is held upright, with the top portion 305 and bottom portion 310 portions of the mobile device centered on the Z axis 325, with some pitch angle margin of error for the mobile device 120 to be held slightly rotated and still be considered in portrait mode.

Landscape mode describes a mobile device orientation where the mobile device 120 held sideways, with the top 305 facing the positive or negative Y 320 directions, and the back of the phone (not shown in FIG. 3) facing in a positive X direction 331, with some pitch 330 angle margin of error for the phone to be held slightly rotated and still be considered in landscape mode.

If the positive Z direction 325 represents 0 degrees of pitch 330, in this orientation, the pitch would measure +/- 90 or +/- 270 degrees, within a landscape specific margin of error. An example margin of error may be +- 5 degrees, 10 degrees, 15 degrees, etc. If the Positive Z direction represents 0 degrees of Pitch, in this case the Pitch would measure 0 or +/- 180 degrees within a Portrait Specific margin of error.

The attitude of the mobile device may determine whether the mobile device 120 has its camera (not shown in FIG. 3) facing away from the user 140. The roll 335 may be a principal source of this determination. In some aspects, if the plane of the camera lens (not shown in FIG. 3) is pointed perpendicular to the ground and facing away from the user 140, and preferably toward the vehicle 105 (as shown in FIG. 1), the HMI quick switch system 107 may determine that the user 140 is actively engaged in the RePA procedure by the merits of capturing an image of the moving vehicle 105 by the camera image processor.

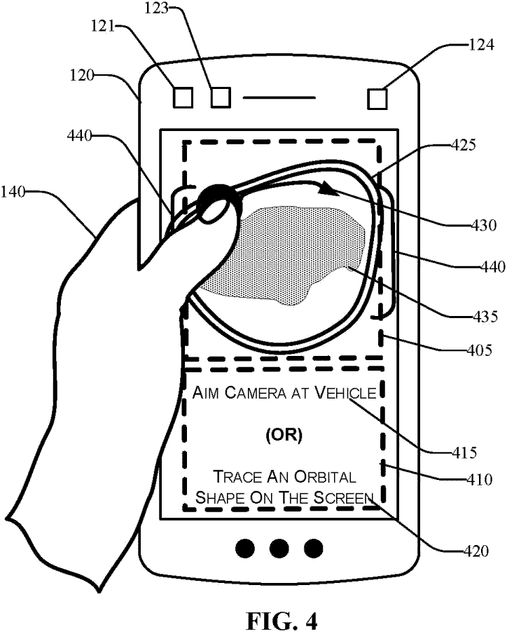

FIG. 4 depicts the mobile device of FIG. 1 generating an aspect of Remote Driver Assist Technology (ReDAT) parking functionality in accordance with embodiments of the present disclosure. The HMI quick switch system 107 (as shown in FIG. 1) may cause the mobile device 120 to provide a rapid or quick transition from an orbital or AR user engagement signal based on user preference, user awareness; how they are engaging/positioning the mobile device 120, and whether the user 140 is pointing the mobile device 120 at the vehicle 105.

FIG. 4 illustrates the mobile device 120 having an AR engagement interface portion 405, and an instruction output portion 410. The HMI quick switch system 107 may present the AR engagement interface portion 405, the instruction output portion 410, or both of the AR engagement interface portion 405 and the instruction output portion 410. For example, the HMI quick switch system 107 may generate user-selectable options that cause the mobile device to issue instructions to the vehicle that cause the vehicle to engage the RePA functionality and perform a parking maneuver.

In one example embodiment, the app presents the user with an interface that includes the AR engagement interface portion 405. The AR engagement interface portion 405 is an area of the app interface that receives user touch input that allows the HMI quick switch system 107, and more particularly the mobile device processor 121, to determine if the user 140 is engaged and/or attentive to the vehicle maneuvering operation. The mobile device processor 121 (as shown in FIG. 1) may present the engagement interface portion 137 responsive to the user digit touching the engagement interface portion 137.

In some aspects, while in landscape mode or portrait mode (shown in FIG. 4), the user 140 can start the tethering function by either using the mobile device camera (e.g., the sensory devices 123), by aiming the mobile device 120 toward the vehicle 105 (or by selecting a user-selectable option that can include one or more instructions portions 415), displayed in portrait mode on the bottom portion of the screen. In other aspects, the user 140 may start to trace the orbital shape input 425 on the upper portion of the screen which includes the AR engagement interface portion 405. In some aspects, when the mobile device 120 is used in portrait mode, the processor 121 may cause the device 120 to output a graphic output of the vehicle 435, and brackets 440 on the top of the screen, while the orbital shape 430 is generated to appear in the user engagement interface portion 137. The processor 121 may cause an HMI associated with the selected option to illuminate, which may indicate a type of engagement the user 140 is currently providing during tethering.

In one aspect, the vehicle-based RePA system 245 (as shown in FIG. 2) may determine that the remote parking functionality onboard the vehicle 105 is ready to begin vehicle motion, and transmit a confirmation signal to the mobile device 120 using the wireless connections 130 (as illustrated in FIG. 1).

Responsive to determining that the mobile device 120 includes a tethering technology that supports orbital motion user engagement determination, such as UWB, via the mobile device screen, the HMI quick switch system 107 may generate instructions that guide the user to properly aim and engage their attention for remote operation. For example, the HMI quick switch system 107, and more particularly, the mobile device processor 121, may cause output that includes a user coaching interface (e.g., the instruction output portion 410, and generate instructions 415, 420 that can cause user 140 to either aim the mobile device camera at the vehicle 105, or provide an orbital shape input 425 on the screen to begin vehicle motion for the desired vehicle feature. The orbital shape input 425 may provide a positive indication that the user 140 is actively engaged in the remote parking procedure.

According to another aspect of the present disclosure, the HMI quick switch system 107 may provide one or more of optical and orbital motion engagement options via separate portions of the screen. The processor 121 may cause the mobile device 120 to output a message requesting that the user press and hold a vehicle motion button. For example, the coaching output instructions 415, 420 may further include text and/or voice such as “Aim Camera at Vehicle OR Trace an Orbital Motion on the Screen.” The HMI quick switch system may display a color shape 430 (e.g., a green orbital shape or curved or other shaped arrow, for example) on the screen of the mobile device 120 in the same color as the text “Trace an Orbital Motion on the Screen” 420, and display a rotating outline of a vehicle 435 displayed inside brackets 440 on the screen in the same color as the text “Aim Camera at Vehicle,” but a different color from the orbital shape.

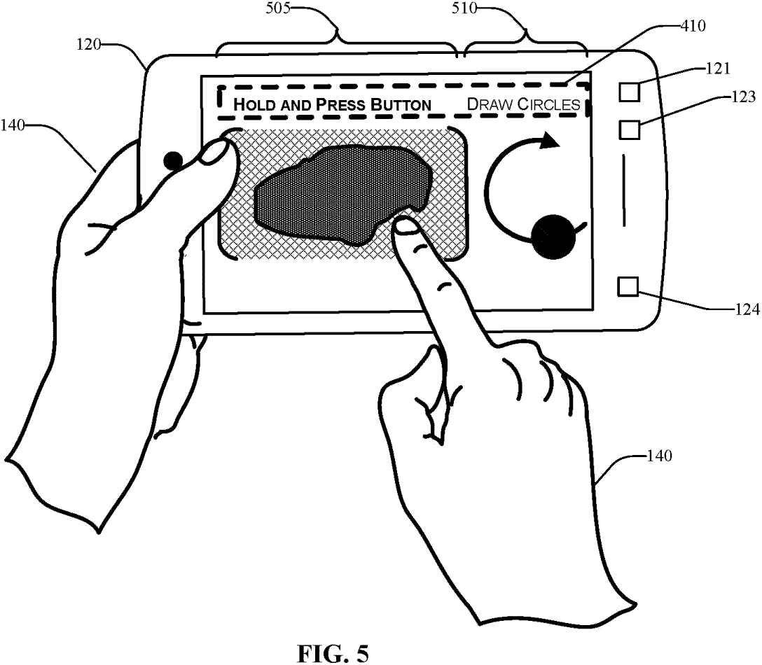

The application 135 may be functional using portrait and landscape viewing modes via the mobile device 120. FIG. 4 illustrates the HMI operating in portrait viewing mode. Responsive to aiming the mobile device camera at the vehicle 105, the application 135 may cause the processor 121 to lock onto the vehicle 105 via UWB tethering, and cause the orbital shape and text to disappear from the user interface. FIG. 5 illustrates this option.

During the tethering process, the processor 121 may generate a switchable user interface such that the user 140 may use to rapidly switch between user engagement options by following the instruction displayed in the instruction output portion 410 generated on the mobile device 120 screen. Responsive to determining that the user wants to shift from optical engagement to orbital motion engagement (e.g., by selecting one of the options 415 and 420 shown in FIG. 4), the processor 121 may provide instructions in a second instruction output portion 410 that causes the user to (1) move the camera away from the vehicle and/or (2) start tracing the orbital shape on the right side of the screen after the HMI lights up. Responsive to determining that the user 140 wants to shift from orbital motion engagement to optical engagement (e.g., AR engagement), the HMI quick switch system 107 may generate instructions in the AR engagement interface portion 405 causing the user 140 to (1) point the camera back to the vehicle 105, (2) stop the complex gesture (e.g., the orbital motion), and/or (3) start holding a highlighted button (described in greater detail with respect to FIG. 5).

FIG. 5 depicts an AR user engagement interface portion 505, and an orbital motion engagement interface portion 510 displayed on the mobile device 120 as it is used in a landscape mode, in accordance with embodiments of the present disclosure. The AR engagement interface may provide means for user engagement via the AR engagement interface by aiming the mobile device 120 at the vehicle 105, and capturing image and/or video input of the scene/vehicle 105 using the onboard sensory devices 124.

Accordingly, in one or more embodiments, the application 135 may cause the processor 121 to lock onto the vehicle 105 in a tethering operation. In one aspect, the mobile device 120 may receive user engagement inputs using the mobile device camera sensors 124, and/or via the user engagement interface portions 505 and 510.

In one example embodiment, the user 140 may aim the mobile device camera sensors 124 at the vehicle 105, and the application 135 may lock onto the vehicle 105. During the tethering process, the HMI quick switch system 107 may provide a switchable user interface (collectively the user engagement interfaces portions 505 and 510), such that the user 140 can switch engagement options from the AR user engagement interface portion 505 and/or the orbital motion engagement interface portion 510. In some aspects, more than two engagement interface portions are possible, and such embodiments are contemplated.

The processor 121 may determine which engagement interface of the user engagement interface portions 505 and 510 the user 140 wishes to utilize, the processor may receive such an indication by means of receiving a touch input. For example, FIG. 5 depicts the user 140 selecting the AR user engagement interface portion 505. In this example, the user 140 may have used the orbital motion engagement interface portion 510 first, but determined that they would now like to switch to the AR user engagement interface portion 505. The tactile input of the user 140 touching the AR user engagement interface 505 may provide the user intention indication to the processor 121 to shift from the orbital motion engagement interface portion 510 to the AR user engagement interface portion 505.

Responsive to determining that the user 140 wants to shift from the AR user engagement interface portion 505 to the orbital motion engagement interface portion 510 , the HMI quick switch system 107 may provide instructions that causes the user to (1) move the camera (e.g., the mobile device 120) away from the vehicle, and/or (2) start tracing the orbital shape input 425 (FIG. 4) in the AR engagement interface portion 405.

Responsive to determining that the user 140 wants to shift from orbital motion engagement (shown in FIG. 4) to optical engagement (shown in FIG. 5), the HMI quick switch system 107 may generate instructions output portion 410, and output the instructions in the 410. During the tethering process, the user 140 can also switch engagement options by following displayed instructions output in the 410. If the user 140 wishes to quickly transition from optical engagement to orbital motion engagement, the processor 121 may determine the user 140 intent to do so based on an orientation of the mobile device 120, based on a selected option (e.g., one or more of a respective instruction in the 410, engagement interface portions 505 and/or 510, etc.) or via another method. In one aspect, the instructions output portion 410 may be to hold and press button, referring to a motion capture button.

In other aspects, the generated instructions may be different. For example, the instructions may cause the user 140 to (1) point the camera back to the vehicle, (2) stop the orbital motion, and/or (3) start holding the highlighted button again. This combination of user input may cause the HMI quick switch system 107 to quickly switch engagement options.

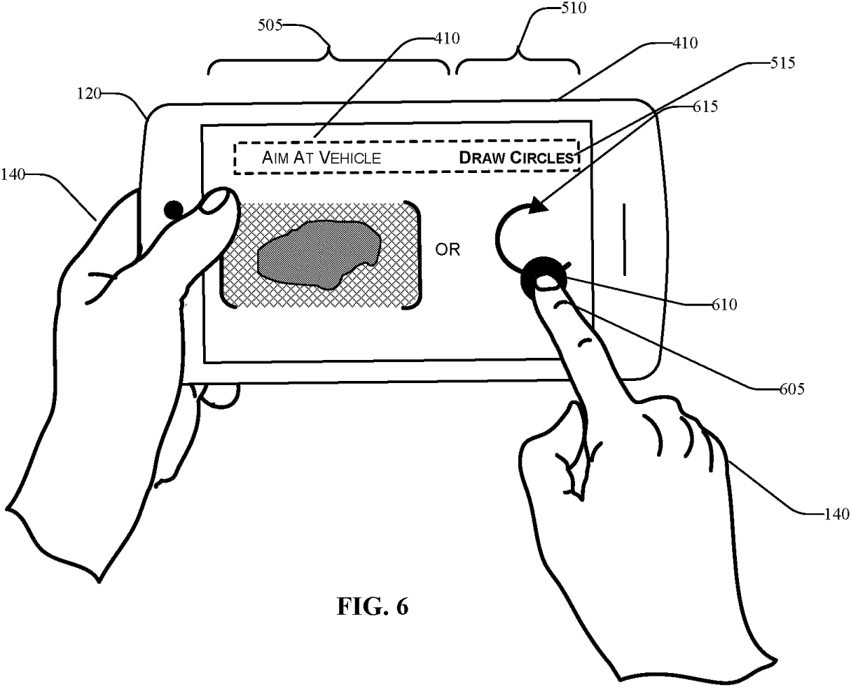

FIG. 6 illustrates switching from an orbital motion engagement interface to an AR engagement user interface, in accordance with embodiments of the present disclosure. In another aspect, the HMI quick switch system 107 may include a third option for quickly switching between control modes. Starting with the same concept of the user 140 beginning a remote vehicle function, before presenting any additional screens to the user 140, the application 135 may cause the processor 121 to evaluate mobile device camera sensors 124 data, and determine one or more control options to be made available to the user 140.

The mobile device camera sensors 124 may provide sensory data (not shown in FIG. 6) usable by the processor 121 to determine an orientation and attitude of the mobile device 120, and select and output an optimized interface. For example, the processor 121 may display an orbital motion engagement interface (as shown in FIG. 4) responsive to determining that the mobile device 120 is in portrait mode. Accordingly, the HMI quick switch system may display an AR engagement interface (as shown in FIG. 5) when the mobile device 120 is positioned in landscape mode.

Based on operational expectations of the mobile device 120 orientation and attitude, if either change during operational use, or do not fall within the guidelines of expected states respective to a particular orientation, the processor 121 may determine if the user 140 has lost focus/awareness and is presenting a “lack of intent” that may be less than adequate for operation of the RePA procedure. Responsive to determining that the user is performing one or more actions that show intent to perform the parking maneuver, and those one or more actions indicate adequate user attention to the task at hand (e.g., the user 140 maintains a threshold level of engagement), the processor 121 may cause one or more vehicle controllers to automatically maneuver the vehicle 105 responsive to determining that the user maintains the threshold level of engagement. As used herein, automatically can mean, among other uses, causing one or more vehicle controllers to perform one or more aspects of vehicle 105 operation including acceleration, braking, steering, keying on, keying off, etc., without any additional user input or with limited additional user input.

For example, using orientation and attitude to measure user intent and determine if the user 140 has lost concentration/focus/awareness, the HMI quick switch system 107 may cause the processor 121 to remind the user (e.g., by displaying a sound, visual, haptic, or other output) indicative that the user 140 is performing a safety-related activity. In other aspects, absent an indication that the user 140 has regained engagement with the RePA procedure, the RePA system may cause the vehicle 105 to stop the procedure.

According to another embodiment, responsive to determining that the mobile device 120 is in a state requiring the mobile device’s orientation and/or attitude to be within a predetermined position, and/or after determining that the mobile device 120 orientation or position with respect to vehicle location does not meet one or more required attributes for system 107 operation (e.g., the user has not maintained the threshold level of engagement, or the user has performed one or more actions, or failed to perform one or more actions that indicate a diminishing but still adequate level of engagement), the HMI quick switch system 107 may generate one or more pulsing, vibrating and/or audio notifications via the mobile device 120, which may cause the user 140 to re-focus user attention to the vehicle control activity. In other aspects, the HMI quick switch system 107 For example, the HMI quick switch system 107 may pulse audio, haptic, or graphical reminders using output capabilities onboard the mobile device 120.

In another aspect, the HMI quick switch system 107 may pulse a set of graphics of one or more active engagement portions by continuously changing the opacity/transparency of active user interface graphics from variations that can include mostly transparent to mostly opaque graphical representations of the scene. In one aspect, the HMI quick switch system may generate the output using one or more predetermined limits for opacity and transparency, and/or one or more predetermined pulsing rates that vary according to the circumstances.

According to another aspect, responsive to determining that a set of graphics for one UI of the two UIs (where the two UIs include the AR engagement interface portion 505, and the orbital motion engagement interface portion 510 ) is actively engaged, system may transition to a different UI functionality such that the active UI’s set of graphics maintain a 100% opacity while the second UI portion (currently unused UI graphics) are rendered with an opacity less than 100%. In one aspect, the UI opacities may be pulsed back and forth from opaque to less-than-opaque, where the pulse rate is based on the predetermined pulse limit and at rate, and the inactive opacity is rendered according to the predetermined inactive opacity. The inactive opacity may be more transparent, for example, such as being 25% opaque, 50% opaque, 10% opaque, etc.

Responsive to determining that neither of the two AR engagement interface portions 505 and 510 is actively engaged, the processor 121 may cause both of the UI’s 505 and 510 to pulse in opposition to each other, such that they pulse back and forth between each respective set of active orbital motion engagement interface portion 510 and inactive AR engagement interface portion 505, respectively. In the case of two sets of user interface graphics being available for use, the HMI quick switch system may cause both sets of graphics to pulse inversely to each other, by causing one set of UI graphics to become increasingly transparent (e.g., as the AR engagement interface portion 505 is depicted as transparent), while the other set of UI graphics (e.g., the active orbital motion engagement interface portion 510) becomes increasingly opaque, or vice versa with each respective pulse.

In another aspect, when the HMI quick switch system 107 includes three or more sets of UIs that are available for use given the particular scene and orientation of the mobile device, the HMI quick switch system 107 may cause one or more of the three sets of graphics (where the third set of UI graphics of the three sets are not shown in FIG. 6) to sequentially pulse between transparent and opaque, such that only one set of the three sets becomes more opaque, while the other two sets of the three available sets is displayed by transitioning from opaque to transparent or mostly transparent (e.g., having the predetermined inactive opacity). In one or more embodiments, the HMI quick switch system 107 may generate the inactive UI output as mostly transparent, then become increasingly opaque with respective pulses.

The example embodiment depicted in FIG. 6 illustrates the user 140 performing an orbital engagement action where the user’s right finger 605 touches the orbital motion engagement interface portion 510 at a touch point 610, and follows an orbital path 615. In one or more embodiments, when the user 140 stops moving their finger 605 along the orbital path 615, but remains in contact with the screen at the touch point 610, the processor 121 may cause the orbital motion engagement interface portion 510 to generate output of a hint message (which may be, for example, text) will Pulse slowly (e.g., at a predetermined pulse rate). Accordingly, the processor 121 may cause the orbital motion engagement interface portion 510 to pulse rapidly (e.g., at a second predetermined pulse rate with respect to the first predetermined pulse rate). The second predetermined pulse rate, being faster, may cause the user 140 to direct their attention back to the AR engagement interface portion 505 and the RePA procedure.

If the user 140 pulls their finger 605 off the touch point 610 at any time during the RePA procedure, or the processor 121 detects another mobile device orientation change such as, for example, returning the mobile device 120 from the landscape orientation as shown in FIG. 6 to a portrait orientation (as shown in FIG. 4), the processor 121 may output the AR engagement interface portions 505 and 510 with original portrait display as illustrated in FIG. 4, with all graphics and text being opaque again.

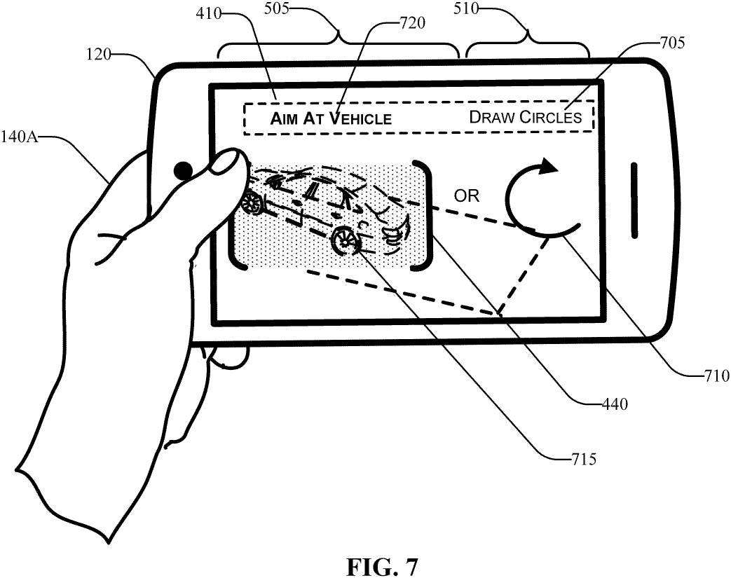

FIG. 7 depicts the mobile device of FIG. 1 providing an augmented reality (AR) user interface that receives camera-based engagement inputs in accordance with embodiments of the present disclosure. FIG. 7 illustrates the AR engagement interface portion 505 in active mode, where the user 140 is pointing the mobile device camera toward the vehicle 105. The AR engagement interface portion 505 depicts the processor 121 causing the mobile device 120 to output a real-time AR output image of the vehicle 715 as it performs RePA maneuvers responsive to determining that the user 140 is engaged with the RePA procedure. It should be appreciated that the depiction of the output image of the vehicle 715, along with other UI elements of the AR engagement interface portion 505 such as the instruction message 720 indicating “Aim At The Vehicle” may be fully opaque. In other aspects one or more of the output images of the vehicle 715 and/or the message 720 may be less-than opaque (or semi-transparent) according to a predetermined active UI opacity setting, as shown in FIG. 7. The UI elements of the orbital motion engagement interface portion 510 may be more transparent than the currently active UI elements, such as the Draw Circles message 705.

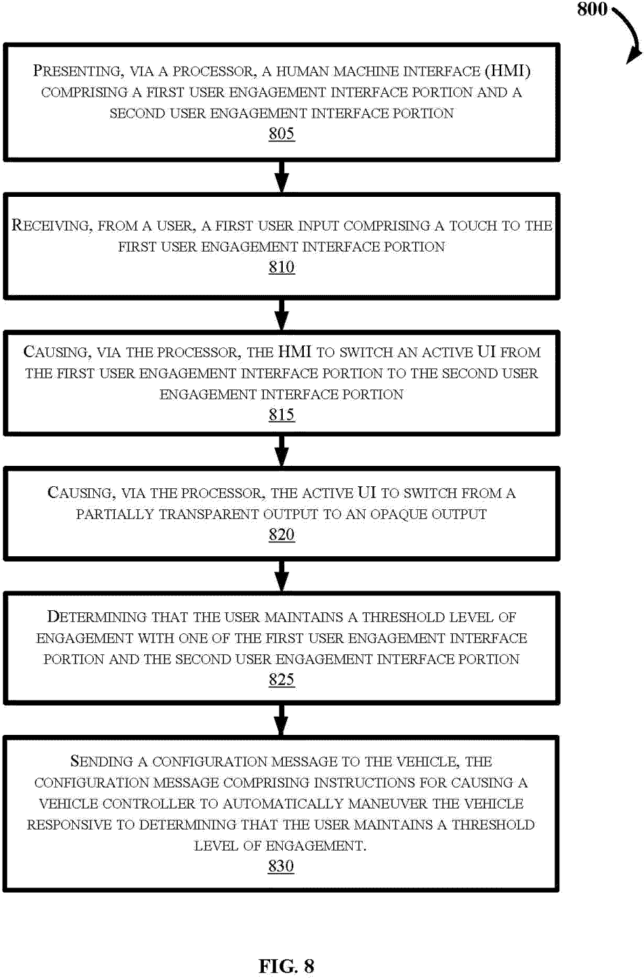

FIG. 8 is a flow diagram of an example method 800 for switching a user interface, according to the present disclosure. FIG. 8 may be described with continued reference to prior figures, including FIGS. 1-7. The following process is exemplary and not confined to the steps described hereafter. Moreover, alternative embodiments may include more or less steps that are shown or described herein, and may include these steps in a different order than the order described in the following example embodiments.

Referring first to FIG. 8, at step 805, the method 800 may commence with presenting, via a processor, a human machine interface (HMI) comprising a first engagement interface portion and a second engagement interface portion. the first engagement interface portion and the second engagement interface portion are presented on a screen of the mobile device simultaneously. In some aspects, the first engagement interface portion comprises a complex gesture engagement interface.

At step 810, the method 800 may further include receiving, from a user, a first user input comprising a touch to the first engagement interface portion. This step may include tethering, via the processor, the mobile device to the vehicle based on the HMI responsive to determining that the mobile device comprises Ultra-Wide Band (UWB) capability. In other aspects, this step may include receiving, from a user, a second user input comprising an orbital shape, and tethering the mobile device to the vehicle responsive to receiving the second user input. In some aspects, this step may further include determining, via the processor, that the user is performing a complex gesture while contacting a touch point disposed in the complex gesture engagement interface, determining, via the processor, that the user has either broken contact with the touch point or ceased performing the complex gesture, and generating, via the processor, a engagement alert responsive to determining that the user has either broken contact with the touch point or ceased performing the complex gesture. the engagement alert comprises one or more of: a text instruction, an auditory alert, a haptic alert, and a change of opacity of a UI element associated with the first engagement interface portion.

At step 815, the method 800 may further include causing, via the processor, the HMI to switch an active UI from the first engagementengagement interface portion to the second engagement interface portion. This step may include presenting a user instruction for active engagement, determining, via the processor, that the user has directed the mobile device away from the vehicle, and receiving, based on the user instruction, a user input comprising a complex gesture. In some embodiments, this step may further include presenting a user instruction for active user engagement, determining, via the processor, that the user has directed the mobile device away from the vehicle, and receiving, based on the user instruction, a user input comprising a complex gesture. This step can also include determining, via the processor, that the user has pressed and held a vehicle motion button.

In one or more embodiments, this step may further include switching the active UI based on a position of the mobile device, the position comprising an orientation of the mobile device and a mobile device attitude. This can include determining, via the processor, that the orientation of the mobile device is portrait mode, and making the first engagement interface portion the active UI based on the orientation of the mobile device being portrait mode. The processor can make the first engagement interface portion the active UI regardless of the mobile device attitude.

The method may further include selecting a predetermined pulse frequency based on an event urgency metric associated with mobile device sensory data, wherein the predetermined pulse frequency comprises a slower frequency associated with a low value for the event urgency metric, and a pulse frequency comprises a faster frequency associated with a high value for the event urgency metric.

In other aspects, this step may further include determining, via the processor, that the user has pressed and held a vehicle motion button. In other aspects, switching the active UI may be based on a position of the mobile device, the position comprising an orientation of the mobile device and a mobile device attitude. Accordingly, this step may further include determining, via the processor, that the orientation of the mobile device is portrait mode, and making the first engagement interface portion the active UI based on the orientation of the mobile device being portrait mode.

At step 820, the method 800 may further include causing, via the processor, the active UI to switch from a partially transparent output to an opaque output. The method may include returning to a portrait display mode responsive to determining that the user has not maintained continuous contact with the first UI portion, and changing an opacity of the UI element comprising user instruction text. Changing the opacity of the UI element can include determining, via the processor, that the mobile device has changed an orientation, and changing the opacity of the first engagement interface portion or the second engagement interface portion based on a predetermined pulse. This may also include pulsing the active UI and an inactive UI in opposition to one another, wherein the pulse inversely affects an opacity of the first engagement interface portion and the second engagement interface portion.

According to another aspect, this step may further include cause one or more graphics of the three sets of graphics to change based on battery level for the mobile device. For example, the HMI quick switch system may determine that less than a threshold battery power level remains, and may cause one or more graphics of the three sets of graphics to change a level of transparency and/or become unelectable. For example, the threshold level of battery power may be 5%, 10%, 20%, etc. At step 825, the method 800 may further include determining that the user maintains a threshold level of engagement with one of the first engagement interface portion and the second engagement interface portion. This step may include determining, via the processor, that the user has not maintained the threshold level of engagement, pulsing, via the processor the first engagement interface portion and the second engagement interface portion by continuously changing an opacity/transparency of an active UI element from mostly transparent to mostly opaque, and outputting an image of a vehicle scene a background of the second engagement interface portion, wherein the vehicle is rendered as the active UI element changing from mostly transparent to mostly opaque.

At step 830, the method 800 may further include sending a configuration message to the vehicle, the configuration message comprising instructions for causing a vehicle controller to automatically maneuver the vehicle responsive to determining that the user maintains a threshold level of engagement.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method for controlling a vehicle via a mobile device, comprising:
presenting, via a processor, a human machine interface (HMI) comprising a first engagement interface portion and a second engagement interface portion;
receiving, from a user, a first input comprising a touch to the first engagement interface portion;
causing, via the processor, the HMI to switch an active UI from the first engagement interface portion to the second engagement interface portion;
causing, via the processor, the active UI to switch from a partially transparent output to an opaque output;
determining that the user maintains a threshold level of engagement with one of the first engagement interface portion and the second engagement interface portion; and
sending a configuration message to the vehicle, the configuration message comprising instructions for causing a vehicle controller to automatically maneuver the vehicle responsive to determining that the user maintains the threshold level of engagement.

2. The method according to claim 1, further comprising.
tethering, via the processor, the mobile device to the vehicle based on the HMI responsive to determining that the mobile device comprises Ultra-Wide Band (UWB) capability.

3. The method according to claim 2, further comprising.
receiving, from the user, a second input comprising an orbital shape; and
tethering the mobile device to the vehicle responsive to receiving the second input.

4. The method according to claim 1, wherein the first engagement interface portion comprises a complex gesture engagement interface.

5. The method according to claim 4, further comprising.
determining, via the processor, that the user is performing a complex gesture while contacting a touch point disposed in the complex gesture engagement interface;
determining, via the processor, that the user has either broken contact with the touch point or ceased performing the complex gesture; and
generating, via the processor, a user engagement alert responsive to determining that the user has either broken contact with the touch point or ceased performing the complex gesture.

6. The method according to claim 5, wherein the user engagement alert comprises one or more of:
a text instruction;
an auditory alert;
a haptic alert; and
a change of opacity of a UI element associated with the first engagement interface portion.

7. The method according to claim 1, wherein causing the HMI to switch the active UI from the first engagement interface portion to the second engagement interface portion comprises:
presenting a user instruction for active user engagement;
determining, via the processor, that the user has directed the mobile device away from the vehicle; and
receiving, based on the user instruction, a user input comprising a complex gesture.

8. The method according to claim 7, further comprising:
determining, via the processor, that the user has pressed and held a vehicle motion button.

9. The method according to claim 1, wherein the first engagement interface portion and the second engagement interface portion are presented on a screen of the mobile device simultaneously.

10. The method according to claim 1, further comprising switching the active UI based on a position of the mobile device, the position comprising an orientation of the mobile device and a mobile device attitude.

11. The method according to claim 10, further comprising:
determining, via the processor, that the orientation of the mobile device is portrait mode; and
making the first engagement interface portion the active UI based on the orientation of the mobile device being portrait mode.

12. The method according to claim 11, wherein the processor makes the first engagement interface portion the active UI regardless of the mobile device attitude.

13. The method according to claim 1, further comprising:
determining, via the processor, that the user has not maintained the threshold level of engagement;
pulsing, via the processor the first engagement interface portion and the second engagement interface portion by continuously changing an opacity/transparency of an active UI element from mostly transparent to mostly opaque; and
outputting an image of a vehicle scene a background of the second engagement interface portion, wherein the vehicle is rendered as the active UI element changing from mostly transparent to mostly opaque.

14. The method according to claim 13, further comprising:
returning to a portrait display mode responsive to determining that the user has not maintained continuous contact with the first engagement interface portion; and
changing an opacity of the active UI element comprising user instruction text.

15. The method according to claim 14, wherein changing the opacity of the active UI element comprises:
determining, via the processor, that the mobile device has changed an orientation; and
changing the opacity of the first engagement interface portion or the second engagement interface portion based on a predetermined pulse.

16. The method according to claim 15, further comprising:
pulsing the active UI and an inactive UI in opposition to one another, wherein the pulse inversely affects the opacity of the first engagement interface portion and the second engagement interface portion.

17. The method according to claim 16, further comprising selecting a predetermined pulse frequency based on an event urgency metric associated with mobile device sensory data, wherein the predetermined pulse frequency comprises a slower frequency associated with a low value for the event urgency metric, and a pulse frequency comprises a faster frequency associated with a high value for the event urgency metric.

18. A system, comprising:
a processor; and
a memory for storing executable instructions, the processor programmed to execute the instructions to:
present, via a Human Machine Interface (HMI) of a mobile device, a first engagement interface portion and a second engagement interface portion;
receive a first input comprising a touch to the first engagement interface portion;
cause the HMI to switch an active user interface (UI) from the first engagement interface portion to the second engagement interface portion;
cause the active UI to switch from a partially transparent output to an opaque output;
determine that a user maintains a threshold level of engagement with one of the first engagement interface portion and the second engagement interface portion; and
send a configuration message to a vehicle communicatively coupled with the mobile device, the configuration message comprising instructions for causing a vehicle controller to automatically maneuver the vehicle responsive to determining that the user maintains the threshold level of engagement.

19. The system according to claim 18, wherein the first engagement interface portion comprises a complex gesture engagement interface, the process executing the instructions to:
determine that the user is performing a complex gesture while contacting a touch point disposed in the complex gesture engagement interface;
determine that the user has either broken contact with the touch point or ceased performing the complex gesture; and
generate a user engagement alert responsive to determining that the user has either broken contact with the touch point or ceased performing the complex gesture.

20. A non-transitory computer-readable storage medium in a mobile device, the computer-readable storage medium having instructions stored thereupon which, when executed by a processor, cause the processor to:
present a first engagement interface portion and a second engagement interface portion;
receive a first input comprising a touch to the first engagement interface portion;
switch an active user interface (UI) from the first engagement interface portion to the second engagement interface portion;
change the active UI to switch from a partially transparent output to an opaque output;
determine that the user maintains a threshold level of engagement with one of the first engagement interface portion and the second engagement interface portion; and
send a configuration message to a vehicle communicatively connected with the mobile device via tethering, the configuration message comprising instructions for causing a vehicle controller to automatically maneuver the vehicle responsive to determining that the user maintains the threshold level of engagement.
